(19) United States
(12) Patent Application Publication
(10) Pub. No.: US 2026/0155325 A1
(43) Pub. Date: Jun. 4, 2026

(54) CONTACTOR BOUNCE REDUCTION

(71) Applicant: Allegro MicroSystems, LLC, Manchester, NH (US)

(72) Inventors: Kavul Tshiloz, Edinburgh (GB); Narasimhan Trichy, Plano, TX (US); Andrea Foletto, Andorno Micca (IT)

(73) Assignee: Allegro MicroSystems, LLC, Manchester, NH (US)

(21) Appl. No.: 18/966,300

(22) Filed: Dec. 3, 2024

(51) Int. Cl. H01H 47/02; H01H 47/00; H01H 47/22

(52) U.S. Cl. CPC H01H 47/02; H01H 47/002; H01H 47/22

(57) ABSTRACT

A method, comprising: identifying a default supply voltage of a relay; identifying an actual supply voltage of the relay; selecting an actual duty cycle based on the actual supply voltage and the default supply voltage; and driving a coil of the relay by using a signal that has the selected actual duty cycle.

### BACKGROUND

Relays are electro-mechanical devices that play a crucial role in controlling electrical circuits. They act as switches that can open or close an electrical connection when an external signal is applied. Essentially, relays serve as intermediaries between low-voltage control systems and high-voltage power circuits, ensuring the safety and efficiency of electrical operations. They are used in a wide range of applications, from industrial automation and manufacturing to telecommunications and automotive systems. Relays are especially valuable when there is a need to isolate low-voltage control circuits from high-voltage or high-current circuits to prevent damage to sensitive components or to control complex sequences of operations.

### SUMMARY

According to aspects of the disclosure, a method is provided, comprising: identifying a default supply voltage of a relay; identifying an actual supply voltage of the relay; selecting an actual duty cycle based on the actual supply voltage and the default supply voltage; and driving a coil of the relay by using a signal that has the selected actual duty cycle.

According to aspects of the disclosure, a method is provided, comprising: identifying a default supply voltage of a relay; identifying an actual supply voltage of the relay; detecting whether the actual supply voltage matches the default supply voltage; when the actual supply voltage matches the default supply voltage, driving a coil of the relay with a signal that is provided by a power source without performing pulse-width modulation on the signal; and when the actual supply voltage does not match the default supply voltage, performing pulse-width modulation on the signal that is provided by the power source and driving the coil of the relay with the pulse-width modulated signal.

According to aspects of the disclosure, a relay is provided, comprising: a moving contact; a coil that is arranged to actuate the moving contact; and a controller that is configured to: identify a default supply voltage of the relay; identify an actual supply voltage of the relay; select an actual duty cycle based on the actual supply voltage and the default supply voltage; and drive the coil by using a signal that has the selected actual duty cycle.

According to aspects of the disclosure, a system is provided, comprising: a moving contact; a coil that is arranged to actuate the moving contact; and a controller that is configured to: identify a default supply voltage of the relay; identify an actual supply voltage of the relay; detect whether the actual supply voltage matches the default supply voltage; when the actual supply voltage matches the default supply voltage, drive the coil with a signal that is provided by a power source without performing pulse-width modulation on the signal; and when the actual supply voltage does not match the default supply voltage, perform pulse-width modulation on the signal that is provided by the power source and drive the coil with the pulse-width modulated signal.

According to aspects of the disclosure, a non-transitory computer-readable medium is provided that stores one or more processor-executable instructions, which, when executed by a processing circuitry of a relay, cause the processing circuitry to perform the operations of: identifying a default supply voltage of the relay; identifying an actual supply voltage of the relay; selecting an actual duty cycle based on the actual supply voltage and the default supply voltage; and driving a coil of the relay by using a signal that has the selected actual duty cycle.

According to aspects of the disclosure, a non-transitory computer-readable medium is provided that stores one or more processor-executable instructions, which, when executed by a processing circuitry of a relay, cause the processing circuitry to perform the operations of: identifying a default supply voltage of the relay; identifying an actual supply voltage of the relay; detecting whether the actual supply voltage matches the default supply voltage; when the actual supply voltage matches the default supply voltage, driving a coil of the relay with a signal that is provided by a power source without performing pulse-width modulation on the signal; and when the actual supply voltage matches the default supply voltage, performing pulse-width modulation on the signal that is provided by the power source and driving the coil of the relay with the pulse-width modulated signal.

### BRIEF DESCRIPTION OF THE DRAWINGS

The foregoing features may be more fully understood from the following description of the drawings in which:

FIG. 1 is a diagram of an example of an electromagnetic relay, according to aspects of the disclosure;

FIG. 2A is a diagram of an example of a relay coil, according to aspects of the disclosure;

FIG. 2B is a graph showing the driving voltage and coil current of the relay of FIG. 1, according to aspects of the disclosure;

FIG. 3A is a graph showing the coil current of the relay of FIG. 1, according to aspects of the disclosure;

FIG. 3B is a diagram of an example of a relay controller that is associated with the relay of FIG. 1, according to aspects of the disclosure;

FIG. 3C is a graph of an example of a coil current response curve, according to aspects of the disclosure;

FIG. 3D is a graph of an example of a coil current response curve, according to aspects of the disclosure;

FIG. 4 is a flowchart of an example of a process, according to aspects of the disclosure;

FIG. 5 is a flowchart of an example of a process, according to aspects of the disclosure;

FIG. 6 is a flowchart of an example of a process, according to aspects of the disclosure;

FIG. 7 is a graph of an example of a coil current response curve, according to aspects of the disclosure;

FIG. 8 shows a table illustrating the respective parameters and outcomes of a series of tests, according to aspects of the disclosure; and

FIG. 9 shows a set of coil current response curves that is associated with the tests of FIG. 8, according to aspects of the disclosure.

### DETAILED DESCRIPTION

Typically, an electric vehicle will have high voltage (HV) relays positioned in the feed from the battery to the electronic motor drivers. The principal function of HV relays is to isolate the battery from the rest of the system when the vehicle is not being used or when an emergency occurs which requires immediate disconnection of the battery for safety reasons. When any of the relays are closed, usually an arcing phenomenon occurs due to the bouncing of the relays' moving contact. The arcing energy can produce severe and gradual destruction of the relay. In other words, the relay's electrical life and contact reliability can be greatly reduced by the relay bouncing.

The present disclosure provides a technique that minimizes the time for which a relay bounces upon being closed. The technique is based on controlling the energization time of the relay's coil by dynamically setting the employed duty cycle based on the relay's supply voltage. The technique is advantageous because it may increase the reliability and lifetime of the relay.

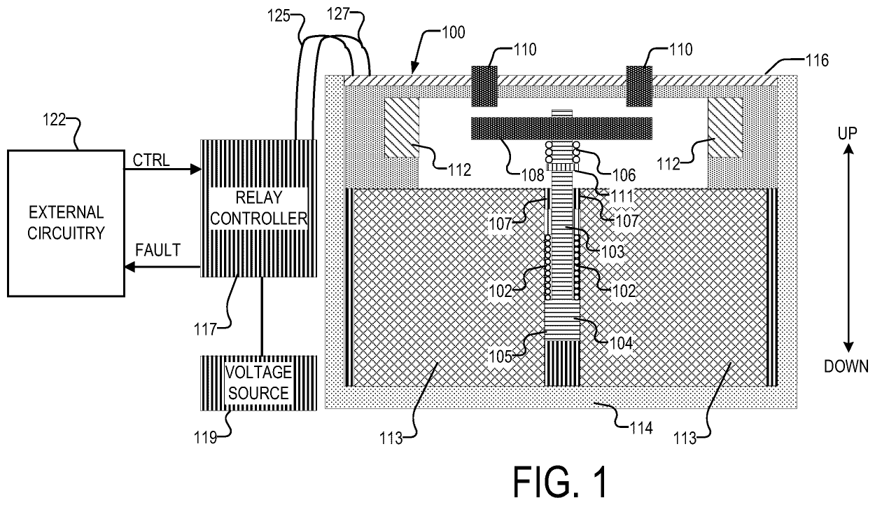

FIG. 1 is a schematic diagram of an example of an electromagnetic relay 100, according to aspects of the disclosure. As illustrated, the relay 100 may include a housing enclosure 114 arranged to contain a moving plunger 104, a moving contact 108 that is coupled to the plunger 104, and a coil 113 that is arranged to actuate the moving contact 108 and plunger 104. The moving plunger 104 may include a portion 103 and a portion 105. Portion 105 may be arranged to engage a return spring 102 that is disposed between portion 105 and a stop 107. The moving contact 108 may be coupled to portion 103 of the plunger 104, as shown. The moving contact 108 may be loosely coupled to portion 103 so that it can move up and down relative to portion 103. An overtravel spring 106 may be disposed between the moving contact 108 and a collar 111. Permanent magnets 112 may be disposed adjacent to the moving contact 108 and fixed contacts 110 may be disposed above the moving contact 108. An epoxy hermetic seal 116 may be arranged to partially encapsulate the fixed contact 110 to prevent moisture from entering the housing enclosure 114.

According to the present example, relay 100 is provided with a relay controller 117. The relay controller 117 may be configured to drive the coil 113 of relay 100. The relay controller 117 may be further configured to detect faults in the relay 100. The relay controller 117 may be configured to generate a fault signal FAULT. When signal FAULT has a first value (e.g., ‘0’), this may be an indication that the relay 100 is not experiencing any faults. When signal FAULT is set to a second value (e.g., ‘1’), this may indicate that relay 100 is experiencing a faulty condition. The fault signal may be provided to external circuitry 122 which is configured to operate the relay 100. The signal FAULT may be generated in accordance with the methods discussed with respect to U.S. patent application Ser. No. 18/818,751 entitled “DETECTION OF RELAY CONTACTOR MOVEMENT” which is hereby incorporated by reference herein in its entirety.

A voltage source 119 may be coupled to the relay controller 117. According to the present example, the voltage source 119 is a battery. However, alternative implementations are possible in which the voltage source 119 includes any suitable type of electronic circuitry that is configured to operate as a power supply for the relay 100. According to the present example, it is the power provided by the voltage source 119 which is used to energize the coil 113 of the relay 100 and actuate the moving contact 108. The voltage source 119 may be arranged to provide either an alternating current (AC) or direct current (DC). Although not shown, the voltage source 119 may include a built-in rectifier or a built-in inverter. Furthermore, the voltage source 119 may include a built-in controller that is configured to provide an indication of the voltage that is output by the voltage source 119 (e.g., 12V, 24V, etc.), as well as other diagnostic or status information.

External circuitry 122 may include a microcontroller and/or any other suitable type of circuitry. External circuitry 122 may be configured to provide relay controller 117 with a control signal CTRL. When signal CTRL is set to a first value (e.g., ‘1’), relay controller 117 may toggle the relay 100 between the active and inactive states. When relay 100 is in the active state, coil 113 is energized, which causes the plunger 104 to move up and bring moving contact 108 into electrical contact with fixed contacts 110, thus allowing electrical current to flow from one of the contacts 110 to the other. When relay 100 is in the inactive state, coil 113 may be de-energized and the return spring 102 may cause the plunger 104 to be separated from the fixed contacts 110, thus interrupting the electrical connection between the fixed contacts 110 and moving contact 108.

FIG. 1 is provided as an example only to illustrate one of many possible architectures that can be used to implement relay 100. In this regard, it will be understood that the relay 100 is not limited to having any specific configuration. For example, in some implementations, relay controller 117 may be integrated into the relay 100. In such implementations, relay controller 117 may be disposed inside the housing enclosure 114 of relay 100. According to the present example, relay 100 is an HV relay that is used in electric vehicles. However, alternative implementations are possible in which relay 100 is a low-voltage relay and/or any other suitable type of relay.

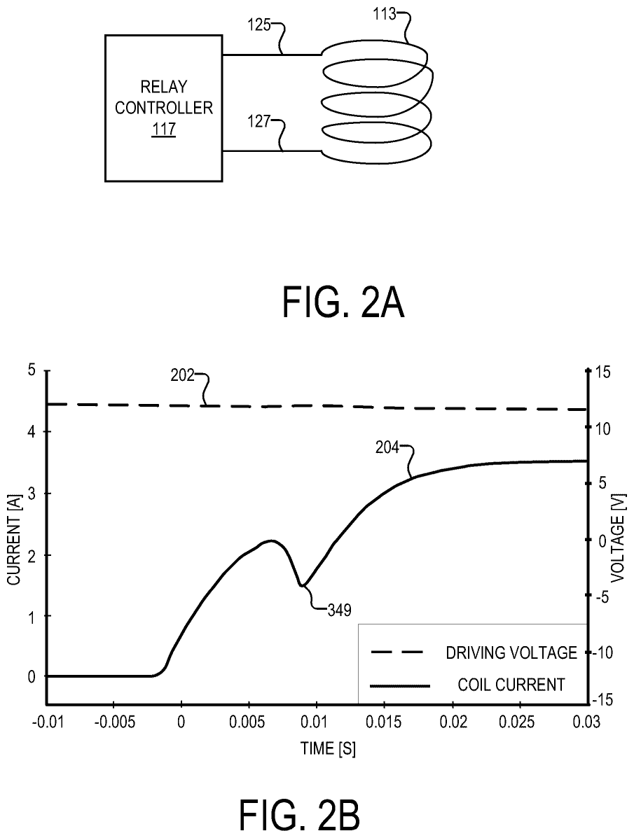

FIG. 2A shows coil 113 in further detail, according to aspects of the disclosure. In the example of FIG. 2A, coil 113 is driven by relay controller 117. As illustrated, coil 113 is coupled to relay controller 117 via conductive lines 125 and 127. One of lines 125 and 127 may be a return line and the other one of lines 125 and 127 may be a supply line for coil 113. When the relay 100 is activated, a voltage may be applied across coil 113 and electric current may begin to flow through the coil 113, which in turn may generate a magnetic field. The magnetic field may cause the plunger 104 to move up and bring the moving contact 108 into electrical contact with the fixed contacts 110. The electrical current through coil 113 is herein referred to as “the coil current of relay 100”. Although not shown in FIG. 2A, there may be additional circuitry disposed between relay controller 117 and the coil 113.

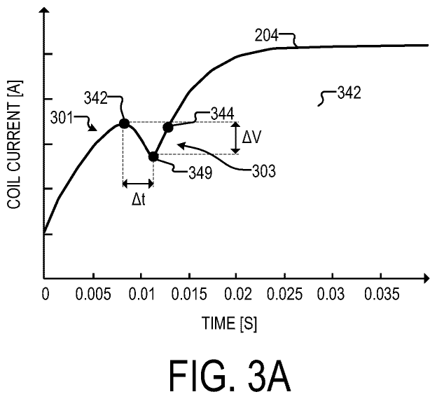

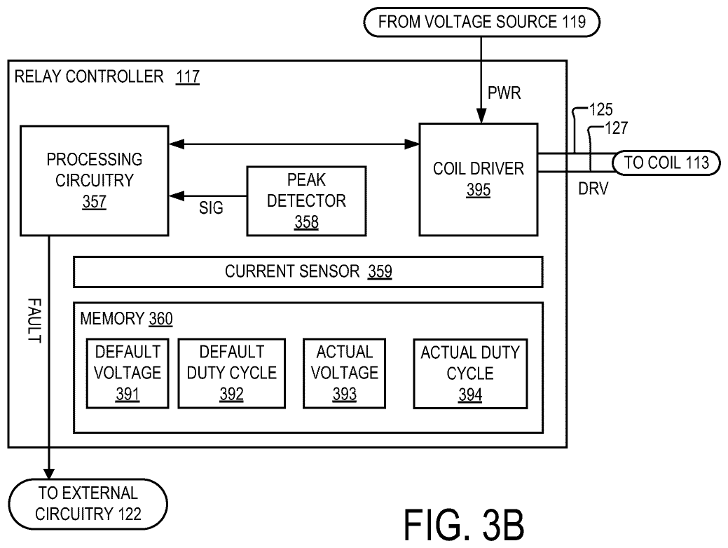

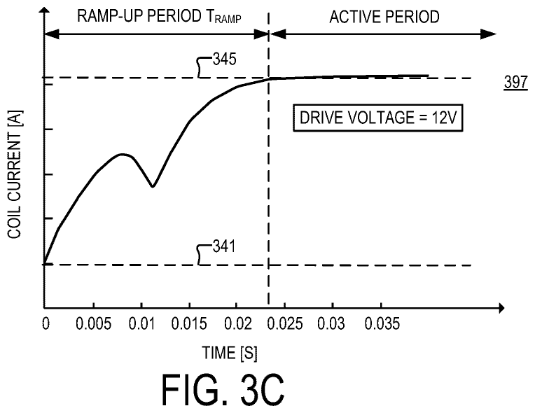

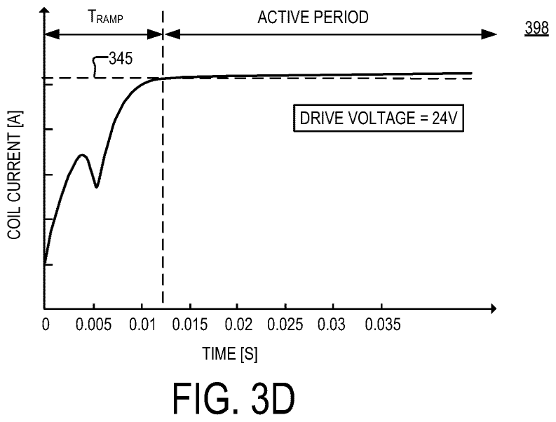

FIG. 2B is a graph illustrating aspects of the operation of coil 113. The graph includes curves 202 and 204. Curve 202 represents the voltage across the coil 113 when the coil is being activated. Curve 204 represents the coil current of relay 100 while the coil is being activated. Curve 204 includes a negative peak 349 that is caused by the back electromotive force (BEMF) which is generated in the opposite direction of the coil current when the plunger 104 starts moving. In the example of FIG. 2B, the supply voltage of relay 100 is already at 12V at time t=0. Once the supply voltage has reached 12V, the output of coil driver 395 (shown in FIG. 3B) is enabled, which causes the coil 113 to become energized.

FIG. 3A shows curve 204 in further detail. As noted above, curve 204 is the response curve of the coil current or relay 100. Curve 204 includes an ascendant part 301 which includes a positive peak 342. The ascendant part 301 is followed by a dip 303 which includes a negative peak 349. The term “positive peak” as used throughout the disclosure refers to a local or global maximum of the waveform of the coil current of relay 100. The term “negative peak” as used throughout the disclosure refers to a local or global minimum of the waveform of the coil current of relay 100.

A metric ΔV is defined as the difference between the positive peak 342 and the negative peak 349. More broadly, the value ΔV may be described as the difference between any positive peak in the waveform of the coil current of relay 100 and the first negative peak in the waveform that occurs after the positive peak.

Furthermore, according to the example of FIG. 3A, a metric Δt is defined as the duration of the period starting when positive peak 342 is reached by the coil current of relay 100 and ending when the coil current has reached a rebound point 344 in the waveform of the coil current of relay 100. Rebound point 344, in the present example, has the same current level as positive peak 342. In this regard, in more broad terms, the value Δt may be described as the time it takes the coil current of relay 100 to generally rebound to the value of its most recent positive peak after it has experienced a dip.

The values of Δt and ΔV are used to generate the signal FAULT. Specifically, when any of the values Δt and ΔV are out of bounds the signal FAULT may be set to a value that is indicative of an error. Otherwise, when the values Δt and ΔV are within bounds, the signal FAULT may be set to a value indicating that the relay 100 is operating normally. In some implementations, the effective detection of faults in the operation of relay 100 may depend on comparing the values Δt and ΔV (or our characteristics of the coil current response) to lower and upper bound thresholds. However, any such comparison would be predicated on the response curve of the coil current of relay 100 having a predictable shape. If the coil current response is not predictable, the comparison would not be guaranteed to work for detecting faults. As is discussed further below, the technique for reducing the bounce time of moving contact 108 has the added advantage of maintaining a predictable shape of the response curve of the coil current of relay 100, which in turn ensures that fault detection algorithms that rely on comparing the values Δt and ΔV against predetermined thresholds work correctly.

FIG. 3B is a diagram of an example of relay controller 117, according to aspects of the disclosure. As illustrated, relay controller 117 may include a processing circuitry 357, a peak detector 358, a current sensor 359, a coil driver 395 and a memory 360. Current sensor 359 may include one or more current sensors that are configured to measure the level of the coil current of relay 100 and provide the measurements to peak detector 358 and/or processing circuitry 357. Memory 360 may include any suitable type of volatile or non-volatile memory. Memory 360 may be used by processing circuitry 357 and peak detector 358 to store information that is generated or otherwise obtained by each of processing circuitry 357 and peak detector 358. Processing circuitry 357 may include any suitable type of digital or analog circuitry. By way of example, processing circuitry 357 may include digital logic, a digital controller, an application-specific circuit, a general-purpose processor, or a special-purpose processor. Peak detector 358 may include a current peak detector with hysteresis. Peak detector 358 may be configured to detect both positive and negative peaks in the coil current of relay 100. In one example, peak detector 358 may generate a signal SIG based on the coil current of relay 100 and provide the signal SIG to processing circuitry 357. Processing circuitry 357 may generate the signal FAULT based on signal SIG and output signal FAULT to external circuitry 122.

Coil driver 395 may include any suitable type of electronic circuitry that is arranged to drive the coil 113 of relay 100. In one example, the coil driver 395 may drive the coil 113 via a signal DRV that is output by coil driver on at least one of lines 125 and 127. The signal DRV may be generated by coil driver 395 based on a signal PWR that is at least in part provided by voltage source 119. In some implementations, the signal DRV may be generated by performing pulse-width modulation on the signal PWR. In instances in which the signal PWR is a DC signal, the pulse-width modulation may be performed by using MOSFETs and/or any other suitable type of circuitry. It will be understood that the present disclosure is not limited to any specific method for performing pulse-width modulation.

An example is now provided of the term “duty cycle”. In general, the term duty cycle may refer to the percentage of one period in which the signal DRV is active. For example, a duty cycle of 100% may mean that the signal DRV is active all the time. Also, when the duty cycle is set to 100%, this may mean that the signal DRV is not pulse-width modulated and/or that no pulse-width modulation is performed on the signal PWR when signal DRV is generated and subsequently used to drive the coil 113 of relay 100. As another example, when the duty cycle is set to 0% this may mean that the signal DRV is turned off all the time. As yet another example, when the duty cycle is set to 50%, this may mean that the signal DRV is active (or turned on) 50% of the time and turned off the other 50% of the time.

The memory 360 may be configured to store an indication 391 of a default voltage of the relay 100, an indication 392 of a default duty cycle of the relay 100, an indication 393 of an actual voltage of the relay 100, and indication 394 of an actual duty cycle of the relay 100. The term default voltage may be a voltage for the power supply of relay 100 that has been confirmed to work well (or in a satisfactory manner) by the designers of relay 100. Additionally or alternatively, the default voltage may be a voltage that is found to produce a certain response curve for the coil current of relay 100. Additionally or alternatively, the default voltage may be a voltage that the relay 100 has been rated for by the manufacturer, with the understanding that the relay may be driven with a different voltage, as well. The default duty cycle of relay 100 may be a duty cycle that has been confirmed to work well (or in a satisfactory manner) by the designers of relay 100. Additionally or alternatively, the default duty cycle may be a duty cycle that is found to produce a certain response curve for the coil current of relay 100. Additionally or alternatively, the default duty cycle may be a duty cycle that the relay 100 has been rated for by the manufacturer, with the understanding that the relay may be driven with a different duty cycle, as well. In some implementations, the values of indications 391 and 392 may be stored in the memory 360 at the factory. In some implementations, the default voltage of relay 100 may be a baseline value against which the actual voltage of relay 100 is compared and used to determine the actual duty cycle of relay 100 (e.g., see equations 1 and 2 below). In some implementations, the default duty cycle of relay 100 may be a baseline value that is used to determine the actual duty cycle of relay 100 (e.g., see equation 2 below).

The actual voltage of relay 100 may be the voltage that is being supplied to relay 100 and used to open and close relay 100. In one example, the actual voltage may be the voltage that is produced by voltage source 119. Additionally or alternatively, the actual voltage may be the voltage which voltage source 119 has been rated for. Additionally or alternatively, the actual voltage may be the voltage that is currently being output by voltage source 119. As is well-known, when voltage source 119 is a battery, the voltage output by the battery may decrease as the battery becomes depleted. In this regard, it will be understood that the term actual voltage may apply cither to the voltage at which the battery is rated or the voltage the battery is capable of producing in its present state, given a specific load, wear, and discharge. Additionally or alternatively, the actual voltage may be the voltage that is applied to the coil 113 and/or any measure that can serve as an indication of the voltage that is applied to the coil 113.

In some implementations, the indication 393 may be stored in the memory 360 by a service technician after relay 100 is deployed. In another example, the actual voltage of relay 100 may be discovered by processing circuitry 357 and the indication 393 may be stored in the memory 360 by the processing circuitry 357. The actual voltage may be discovered by processing circuitry 357 performing a handshake with a controller (not shown) which is built into the voltage source 119. As another example, the actual voltage may be discovered by using a sensing resistor or other voltage-metering circuitry that is built into relay controller 117.

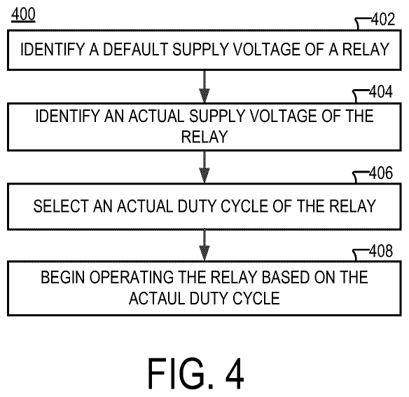

The actual duty cycle of relay 100 may be the duty cycle of signal DRV. The value of the actual duty cycle may be calculated dynamically by processing circuitry 357. In one implementation, the value of the actual duty cycle may be calculated in accordance with one of processes 400-600, which are discussed further below with respect to FIGS. 4-6.

According to aspects of the disclosure, the phrase “identifying the default supply voltage of relay 100” may refer to retrieving from memory 360 the indication 391 of the default supply voltage of relay 100. According to aspects of the disclosure, the phrase “identifying the default duty cycle of relay 100” may refer to retrieving from memory 360 the indication 392 of the default duty cycle. According to the aspects of the disclosure, the phrase identifying the “actual supply voltage of relay 100” may refer to retrieving from memory 360 the indication 393 of the actual supply voltage of relay 100. Additionally or alternatively, the phrase identifying the “actual supply voltage of relay 100” may refer to using a sensing resistor (and/or other voltage metering circuitry) to determine the actual supply voltage of relay 100. Additionally or alternatively, the phrase identifying the “actual supply voltage of relay 100” may refer to executing a handshake between processing circuitry 357 and a controller of the voltage source 119 to determine the actual supply voltage of relay 100.

FIG. 3B is provided as an example only to show one of many possible implementations of relay controller 117. It will be understood that relay controller 117 can be implemented by using any suitable type of digital and/or analog circuitry. Stated succinctly, the present disclosure is not limited to any specific implementation of relay controller 117.

An example is now provided of the term “contact bounce”. Contact bounce is a condition that occurs when a relay does not close cleanly and instead makes and breaks contact, before making contact again. A contact bounce may be a sign that a relay is on the way to failing and in need of being replaced. Contact bounce is undesirable as it could lead to unintended pulses, noise, and logic errors. Contact bounce may be identified by counting the number of dips (or negative peaks) in the waveform of the coil current of relay 100. Contact bounce may occur when moving contact 108 touches fixed contacts 110 (shown in FIG. 1) and is deflected from fixed contacts 110 due to the force at which moving contact 108 is ejected into fixed contacts 110. When contact bounce occurs, relay 100 may experience increased wear. For example, sparks may fly and/or carbon might built into the relay 100. Also, the moving contact 108 and/or its actuating assembly may become bent, broken, or otherwise damaged.

An example is now provided of the term bounce time. As the name suggests, the bounce time T_{BOUNCE} of relay 100 may be the duration of the period in which relay 100 experiences a contact bounce upon being closed. In one example, the bounce time of relay 100 may be the duration of the period starting when the moving contact 108 first touches fixed contacts 110 and ending when moving contact 108 is at rest while remaining in electrical contact with fixed contacts 110. The duration of the period T_{BOUNCE} is indicative of the amount of wear that is imparted on relay 100 when relay 100 is closed. In general, the longer the duration, the greater the wear that is experienced (e.g., because of sparks flying and carbon building up, etc.).

FIG. 3C shows a graph of a curve 397, according to aspects of the disclosure. Curve 397 shows the response of the coil current of relay 100 when the default voltage of relay 100 is the same as the actual voltage of relay 100. In the example of FIG. 3C, both the default voltage and the actual voltage are equal to 12V. As illustrated, the coil current rises, then experiences a dip, and then rises again until the threshold 345 is crossed. When the threshold 345 is crossed, the moving contact 108 has made physical contact with fixed contacts 110. In other words, the crossing of threshold 345, by the coil current of relay 100, marks the coming into physical contact of the moving contact 108 with the fixed contacts 110.

The ramp-up period T_{RAMP} is the period ending when the coil current of relay 100 crosses the threshold 345. In one example, the ramp-up period T_{RAMP} may begin when the coil current of relay 100 crosses a threshold 341 that is lower than the threshold 345. In another example, the ramp-up period T_{RAMP} may begin when coil 113 is energized. In yet another example, the ramp-up period T_{RAMP} may begin when the coil driver 395 enters a state in which it energizes the coil 113 of relay 100. In any event, the ramp-up period T_{RAMP} is a measure of how long it takes for moving contact 108 to travel from a first position to a second position. The first position may be a position assumed by moving contact 108 when relay 100 is inactive. The second position may be a position assumed by relay 100 when moving contact 108 is in physical contact with fixed contacts 110. Coincidentally, the ramp-up period T_{RAMP} is also a measure of the speed at which moving contact 108 travels toward fixed contacts 110 when relay 100 is being closed.

FIG. 3D is a diagram of a curve 398, according to aspects of the disclosure. Curve 398 shows the response of the coil current of relay 100 when the actual voltage of relay 100 is double the default voltage of relay 100. In the example of FIG. 3D, the actual voltage of relay 100 is 24V and the default voltage of relay 100 is 12V. In the example of FIG. 3D, the length of the ramp-up period T_{RAMP} is significantly shorter than the duration of the ramp-up period T_{RAMP} in the example of FIG. 3C. FIGS. 3C-D are provided to illustrate that there is an inverse relationship between the actual voltage of relay 100 and the length of the ramp-up period T_{RAMP}—i.e., the greater the voltage that is used to drive the coil of relay of 100, the shorter the ramp-up period T_{RAMP}.

The length of the ramp-up period T_{RAMP} is inversely proportional to the duration of the period T_{BOUNCE}. In general, the shorter the ramp-up period T_{RAMP}, the greater the force at which the moving contact 108 would slam against fixed contacts 110, and thus the longer the time for which moving contact 108 would bounce back and forth until settling in the closed position (i.e., the position in which moving contact 108 is electrical contact with fixed contacts 110 and relay 100 is considered to be in the active state).

The discussion that follows provides several examples of a technique for reducing the duration of the period T_{BOUNCE} and maintaining the duration of the ramp-up period T_{RAMP} at a reasonable, and/or predetermined, length. In general terms, the technique involves dynamically reducing the duty cycle of signal DRV when the actual voltage of relay 100 is higher than the default voltage of relay 100. Reducing the duty cycle of signal DRV causes the duration of the ramp-up period T_{RAMP} to be maintained at a value that is associated with an acceptable duration of the period T_{BOUNCE} and/or acceptable wear of relay 100.

FIG. 4 is a flowchart of an example of a process 400, according to aspects of the disclosure. According to the example of FIG. 4, process 400 is performed by processing circuitry 357 of relay controller 117 (shown in FIG. 3B). However, the present disclosure is not limited to any specific entity or set of entities executing the process 400.

At step 402, processing circuitry 357 identifies the default supply voltage of relay 100. In some implementations, the default supply voltage may be identified in the manner discussed above with respect to FIG. 3B.

At step 404, processing circuitry 357 identifies the actual supply voltage of relay 100. In some implementations, the actual supply voltage may be identified in the manner discussed above with respect to FIG. 3B.

At step 406, processing circuitry 357 selects the actual duty cycle of relay 100. In one example, selecting the actual duty cycle may include calculating the actual duty cycle in accordance with equation 1 below:

$${D}_{A} = ( \frac{{V}_{D}}{{V}_{A}} ) * K \qquad ( 1 )$$

where D_{A} is the actual duty cycle, V_{D} is the default supply voltage (identified at step 402), V_{A} is the actual supply voltage (identified at step 404), and K is a predetermined constant. Equation 1 is provided as an example only. It will be understood that any other equation can be used in place of equation 1 which establishes an inverse relationship between the value of the actual duty cycle and the amount by which the actual supply voltage exceeds the default supply voltage (when the actual supply voltage indeed exceeds the default supply voltage).

At step 408, processing circuitry 357 begins operating relay 100 in accordance with the actual duty cycle (selected at step 406). In one example, beginning to operate relay 100 in accordance with the actual duty cycle may include taking any action that would cause signal DRV to have the actual duty cycle that is selected at step 406. Additionally or alternatively, beginning to operate relay 100 in accordance with the actual duty cycle may include taking any action that would cause coil driver 395 to impart the actual duty cycle (selected at step 406) on signal DRV (and/or signal PWR). Additionally or alternatively, beginning to operate relay 100 in accordance with the actual duty cycle may include energizing coil 113 with a signal having the actual duty cycle that is selected at step 406. Additionally or alternatively, beginning to operate relay 100 in accordance with the actual duty cycle (selected at step 406) may include storing in memory 360 an indication of the actual duty cycle.

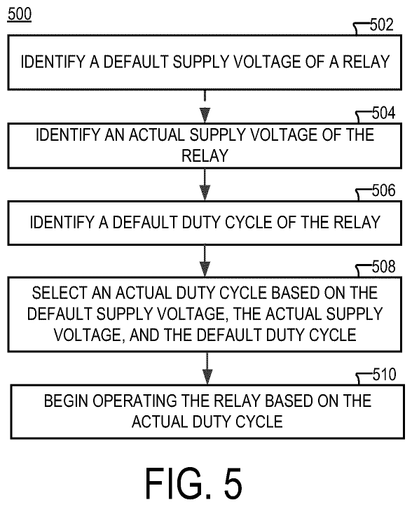

FIG. 5 is a flowchart of an example of a process 500, according to aspects of the disclosure. According to the example of FIG. 5, process 500 is performed by processing circuitry 357 of relay controller 117 (shown in FIG. 3B). However, the present disclosure is not limited to any specific entity or set of entities executing the process 500.

At step 502, processing circuitry 357 identifies the default supply voltage of relay 100. In some implementations, the default supply voltage may be identified in the manner discussed above with respect to FIG. 3B.

At step 504, processing circuitry 357 identifies the actual supply voltage of relay 100. In some implementations, the actual supply voltage may be identified in the manner discussed above with respect to FIG. 3B.

At step 506, processing circuitry 357 identifies the default duty cycle of relay 100. In some implementations, the default duty cycle may be identified in the manner discussed above with respect to FIG. 3B.

At step 508, processing circuitry 357 selects the actual duty cycle for relay 100. In one example, selecting the actual duty cycle may include calculating the actual duty cycle in accordance with equation 2 below:

$${D}_{A} = ( \frac{{V}_{D}}{{V}_{A}} ) * {D}_{D} \qquad ( 2 )$$

where D_{A} is the actual duty cycle, V_{D} is the default supply voltage (identified at step 502), V_{A} is the actual supply voltage (identified at step 504), and D_{D} is the default duty cycle. Equation 2 is provided as an example only. It will be understood that any other equation can be used in place of equation 2 which establishes an inverse relationship between the value of the actual duty cycle and the amount by which the actual supply voltage exceeds the default supply voltage, whereby the actual duty cycle is specified as a fraction of the default duty cycle (assuming V_{A}>V_{D}).

At step 510, processing circuitry 357 begins operating relay 100 in accordance with the actual duty cycle (selected at step 508). In one example, beginning to operate relay 100 in accordance with the actual duty cycle may include taking any action that would cause signal DRV to have the actual duty cycle that is selected at step 508. Additionally or alternatively, beginning to operate relay 100 in accordance with the selected duty cycle may include taking any action that would cause coil driver 395 to impart the actual duty cycle (selected at step 508) on signal DRV (and/or signal PWR). Additionally or alternatively, beginning to operate relay 100 in accordance with the actual duty cycle may include energizing coil 113 with a signal having the actual duty cycle that is selected at step 508. Additionally or alternatively, beginning to operate relay 100 in accordance with the actual duty cycle (selected at step 508) may include storing in memory 360 an indication of the actual duty cycle.

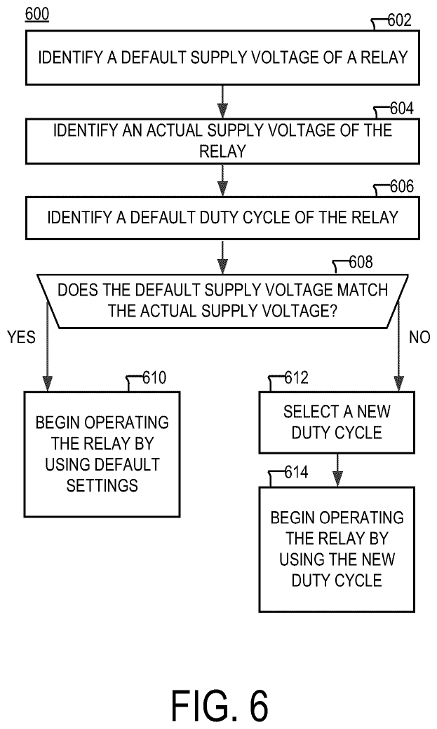

FIG. 6 is a flowchart of an example of a process 600, according to aspects of the disclosure. According to the example of FIG. 6, process 600 is performed by processing circuitry 357 of relay controller 117 (shown in FIG. 3B). However, the present disclosure is not limited to any specific entity or set of entities executing the process 600.

At step 602, processing circuitry 357 identifies the default supply voltage of relay 100. In some implementations, the default supply voltage may be identified in the manner discussed above with respect to FIG. 3B.

At step 604, processing circuitry 357 identifies the actual supply voltage of relay 100. In some implementations, the actual supply voltage may be identified in the manner discussed above with respect to FIG. 3B.

At step 606, processing circuitry 357 identifies the default duty cycle of relay 100. In some implementations, the default duty cycle may be identified in the manner discussed above with respect to FIG. 3B.

At step 608, processing circuitry 357 detects whether the actual supply voltage matches the default supply voltage. In one example, the two supply voltages may match if one is equal to the other. If they are different, the two supply voltages may not match each other. In another example, the two supply voltages may be considered to not match if the absolute value of the difference between the two supply voltages is greater than a threshold. If the absolute value is less than the threshold, the two supply voltages may be considered to match. If the two supply voltages match, process 600 proceeds to step 610. Otherwise, if the two supply voltages do not match, process 600 proceeds to step 612.

At step 610, processing circuitry 357 begins to operate relay 100 by using the default settings of relay 100. Specifically, at step 610, processing circuitry 357 begins to operate relay 100 by using the default duty cycle of relay 100 as the relay's actual duty cycle. In one example, beginning to operate relay 100 in accordance with the default duty cycle may include taking any action that would cause signal DRV to have the default duty cycle. Additionally or alternatively, beginning to operate relay 100 in accordance with the default duty cycle may include taking any action that would cause coil driver 395 to impart the default duty cycle on signal DRV. Additionally or alternatively, beginning to operate relay 100 in accordance with the default duty cycle may include energizing coil 113 with a signal that has the default duty cycle.

At step 612, processing circuitry 357 selects a new actual duty cycle of relay 100. The new actual duty cycle may be selected based on the actual and default supply voltages of relay 100, which are identified at steps 604 and 602, respectively. By way of example, the new actual duty cycle may be selected in accordance with equation 1, which is discussed above with respect to FIG. 4. Additionally or alternatively, the new actual duty cycle may be selected based on the actual and default supply voltages of relay 100 (identified at steps 602-604), as well as the default duty cycle (identified at step 606). By way of example, the new actual duty cycle may be selected in accordance with equation 2, which is discussed above with respect to FIG. 5.

At step 614, processing circuitry 357 begins to operate relay 100 in accordance with the new actual duty cycle (selected at step 612). In one example, beginning to operate relay 100 in accordance with the new actual duty cycle may include taking any action that would cause signal DRV to have the actual duty cycle that is selected at step 612. Additionally or alternatively, beginning to operate relay 100 in accordance with the new actual duty cycle may include taking any action that would cause coil driver 395 to impart the actual duty cycle (selected at step 612) on signal DRV. Additionally or alternatively, beginning to operate relay 100 in accordance with the new actual duty cycle may include energizing coil 113 with a signal having the duty cycle that is selected at step 612. Additionally or alternatively, beginning to operate relay 100 in accordance with the actual duty cycle (selected at step 508) may include storing in memory 360 an indication of the actual duty cycle.

In some implementations, when relay 100 is operated in accordance with the default duty cycle, no pulse-width modulation may be applied on signal PWR when generating signal DRV (and/or signal PWR may be directly used as the drive signal DRV). On the other hand, when relay 100 is operated in accordance with the new actual duty cycle (selected at step 612), pulse width modulation may be applied on signal PWR in order to generate signal DRV. When no pulse-width modulation is applied on signal PWR, signal DRV may have the same waveform, frequency, and/or phase as signal PWR. When pulse-width modulation is applied on signal PWR in order to generate signal DRV, signal DRV may have a different waveform, frequency, and/or phase as signal PWR. Additionally, alternatively, when pulse width modulation is applied on signal PWR, signal PWR may be switched on and off (or otherwise gated) in order to generate signal DRV, whereas this may not be the case when no pulse-width modulation is being applied.

In some implementations, at step 610, processing circuitry 357 may disable a modulation circuit, which is part of coil driver 395, and which is responsible for performing pulse-width modulation on signal PWR. Additionally or alternatively, at step 610, if the modulation circuit was already disabled when step 608 was executed, processing circuitry 357 may allow the modulation circuit to remain disabled. In some implementations, at step 614, processing circuitry 357 may enable the modulation circuit. Additionally or alternatively, at step 614, if the modulation circuit was already enabled when step 614 was executed, processing circuitry 357 may allow the modulation circuit to remain enabled.

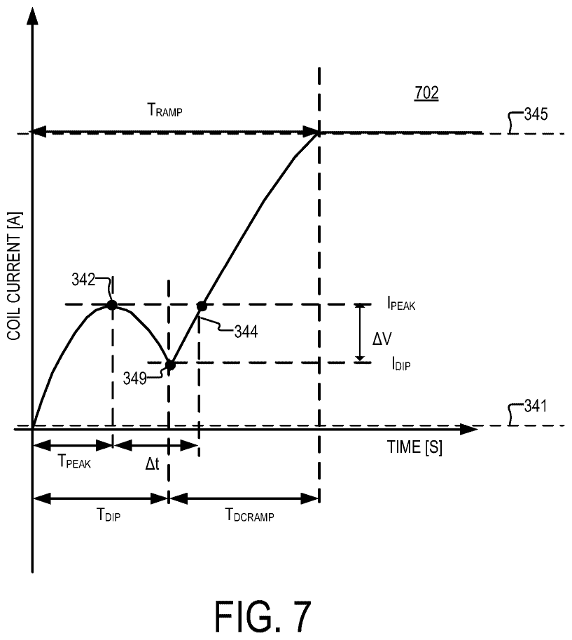

FIG. 7 is a graph of a curve 702. In the example of FIG. 7, curve 702 is the response curve of the coil current of relay 100. The shape of curve 702 may be described in terms of quantities I_{PEAK}, I_{DIP}, T_{RAMP}, T_{PEAK}, T_{DIP}, and T_{DCRAMP}. I_{PEAK} may be the level of positive peak 342, I_{DIP} may be the level of negative peak 349. T_{PEAK} may be the delay between the start of a period of interest and the point in time when the coil current of relay 100 reaches the value I_{PEAK}. T_{DIP} may be the delay between the start of a period of interest and the point in time when the coil current of relay 100 reaches the value I_{DIP}. T_{DCRAMP} may be the delay between the point in time when the coil current of relay 100 reaches value I_{DIP} and the point in time when the coil current of relay crosses the threshold 345. T_{RAMP} may be the delay of the period of interest and the point in time when the coil current of relay 100 crosses the threshold 345. The period of interest may start when the coil current of relay 100 crosses threshold 341, when the coil driver 395 (shown in FIG. 3C) receives an instruction (or signal) to energize coil 113, and/or when any other suitable condition is met.

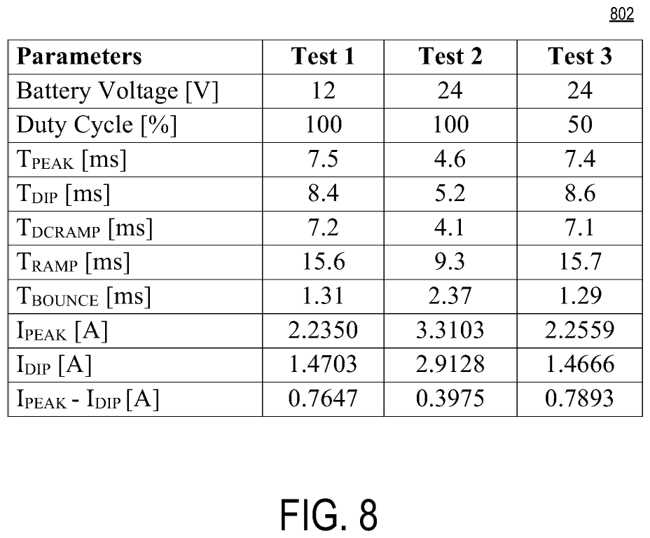

FIG. 8 shows a table 802 which contains the respective parameters and outcomes of three different simulations that were performed of the technique discussed with respect to FIGS. 4-6. The simulations are herein referred to as Test 1, Test 2, and Test 3. In each of the simulations, the coil 113 of relay 100 is driven with a different combination of actual supply voltage and actual duty cycle, and the resulting values of I_{PEAK}, I_{DIP}, T_{RAMP}, T_{PEAK}, T_{DIP}, and T_{DCRAMP} are recorded. More specifically, in Test 1, the actual voltage of relay 100 is the same as the default voltage (i.e., 12V), and the actual duty cycle of relay 100 is the same as the default duty cycle (i.e., 100%). In Test 2, the actual supply voltage of relay 100 (i.e., 24V) is double the default supply voltage (i.e., 12V), and the actual duty cycle of relay 100 is the same as the default duty cycle (i.e., 100%). In Test 3, the actual supply voltage of relay 100 (i.e., 24V) is double the default supply voltage (i.e., 12V), and the actual duty cycle of relay 100 (i.e., 50%) is half the default duty cycle (i.e., 100%). Also shown in table 802, are the values of the parameters of the response curve of the coil current of relay 100. As noted above with respect to FIG. 7, these parameters include I_{PEAK}, I_{DIP}, T_{RAMP}, T_{PEAK}, T_{DIP}, and T_{DCRAMP}, and they describe the shape of the coil current response curve.

Further shown in table 802 is the value of the bounce time T_{BOUNCE} of relay 100. In Test 1, the value of the bounce time T_{BOUNCE} is 1.31 ms. In Test 2, the value of the bounce time T_{BOUNCE} is 2.37 ms. And in Test 3, the value of the bounce time T_{BOUNCE} is 1.29 ms. In this regard, table 802 shows that increasing the actual supply voltage of relay 100, while keeping the actual duty cycle of relay 100 the same, increases the bounce time T_{BOUNCE} which in turn results in an increased wear of relay 100. (E.g., compare Test 1 to Test 2.) Furthermore, table 802 shows that increasing the actual supply voltage of relay 100, while decreasing the actual duty cycle of relay 100, has the effect of keeping the bounce time T_{BOUNCE} more or less the same, which in turn may result in keeping the wear of relay 100 within acceptable limits. (E.g., compare Test 1 to Test 3.)

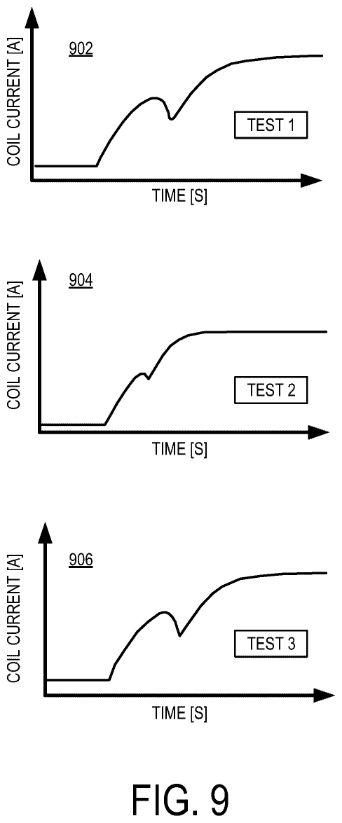

FIG. 9 shows graphs 902, 904, and 906 of the response of the coil current of relay 100. Specifically, graph 902 shows the response curve of the coil current of relay 100, which results when Test 1 is performed. Graph 904 shows the response curve of the coil current of relay 100, which results when Test 2 is performed. Graph 906 shows the response curve of the coil current of relay 100, which results when Test 3 is performed.

FIG. 9 illustrates that the response curve of the coil current of relay 100 is largely the same in Tests 1 and 3. In this regard, FIG. 9 illustrates that the technique discussed with respect to FIGS. 4-6 has the tendency to preserve the shape (and/or proportionality) of the response curve of the coil current of relay 100. This is advantageous because many algorithms that are deployed by processing circuitry 357 when generating the signal FAULT may rely in one form or another on comparing the values I_{PEAK}, I_{DIP}, T_{RAMP}, T_{PEAK}, T_{DIP}, and T_{DCRAMP} and/or values Δt and ΔV (shown in FIG. 3A) against predetermined thresholds. These algorithms may depend on the values being within certain ranges and/or the response curve of the coil current exhibiting a certain proportionality. In this regard, maintaining the shape of the response curve of the coil current is advantageous because it increases the likelihood (or ideally guarantees) that the algorithms for generating signal FAULT would work correctly. If the shape of the response curve is not maintained, the algorithms may not be able to operate properly.

Throughout the disclosure, like callout numbers refer to like parts. FIGS. 4-6 are provided as an example only. At least some of the steps performed in any of processes 400, 500, and 600 (shown in FIGS. 4-6) may be performed in a different order, in parallel, or altogether omitted.

The concepts and ideas described herein may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers). Each such program may be implemented in a high-level procedural or object-oriented programming language to work with the rest of the computer-based system. However, the programs may be implemented in assembly, machine language, or Hardware Description Language. The language may be a compiled or an interpreted language, and it may be deployed in any form, including as a stand-alone program or as a module, component, subroutine, or another unit suitable for use in a computing environment. A computer program may be deployed to be executed on one computer or multiple computers at one site or distributed across multiple sites and interconnected by a communication network. A computer program may be stored on a non-transitory machine-readable medium that is readable by a general or special-purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, or volatile memory. The term unit (e.g., an addition unit, a multiplication unit, etc.), as used throughout the disclosure may refer to hardware (e.g., an electronic circuit) that is configured to perform a function (e.g., addition or multiplication, etc.), software that is executed by at least one processor, and configured to perform the function, or a combination of hardware and software.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Having described preferred embodiments, which serve to illustrate various concepts, structures and techniques, which are the subject of this patent, it will now become apparent that other embodiments incorporating these concepts, structures and techniques may be used. Accordingly, it is submitted that the scope of the patent should not be limited to the described embodiments but rather should be limited only by the spirit and scope of the following claims.

1. A method, comprising:
identifying a default supply voltage of a relay;
identifying an actual supply voltage of the relay;
selecting an actual duty cycle based on the actual supply voltage and the default supply voltage; and
driving a coil of the relay by using a signal that has the selected actual duty cycle.

2. The method of claim 1, wherein the default supply voltage of the relay is a supply voltage the relay is rated for, and the actual supply voltage of the relay is a voltage that is produced by a power source used to open and close the relay.

3. The method of claim 1, wherein the actual supply voltage is greater than the default supply voltage, and selecting the actual duty cycle includes scaling down a default duty cycle based on an amount by which the actual supply voltage exceeds the default supply voltage.

4. The method of claim 1, wherein the actual duty cycle is selected based on a ratio between the default supply voltage and the actual supply voltage.

5. The method of claim 1, wherein identifying the default supply voltage of the relay includes retrieving from a memory an indication of the default supply voltage of the relay.

6. The method of claim 1, wherein identifying the actual supply voltage of the relay includes executing a handshake with a controller of a battery that is used to open and close the relay to discover a voltage that is produced by the battery.

7. A method, comprising:
identifying a default supply voltage of a relay;
identifying an actual supply voltage of the relay;
detecting whether the actual supply voltage matches the default supply voltage;
when the actual supply voltage matches the default supply voltage, driving a coil of the relay with a signal that is provided by a power source without performing pulse-width modulation on the signal; and
when the actual supply voltage does not match the default supply voltage, performing pulse-width modulation on the signal that is provided by the power source and driving the coil of the relay with the pulse-width modulated signal.

8. The method of claim 7, wherein the default supply voltage matches the actual supply voltage when the actual supply voltage is the same as the default supply voltage, and the default supply voltage does not match the actual supply voltage when the actual supply voltage is different from the default supply voltage.

9. The method of claim 7, wherein the default supply voltage matches the actual supply voltage when the absolute value of a difference between the default supply voltage and the actual supply voltage does not exceed a predetermined threshold, and the actual supply voltage does not match the default supply voltage when the absolute value exceeds the predetermined threshold.

10. The method of claim 7, wherein the default supply voltage of the relay is a supply voltage the relay is rated for, and the actual supply voltage of the relay is a voltage that is produced by a power source used to open and close the relay.

11. The method of claim 7, further comprising selecting an actual duty cycle based on the default supply voltage and the actual supply voltage, wherein the pulse-width modulation is performed in accordance with the actual duty cycle.

12. The method of claim 11, wherein the actual supply voltage is greater than the default supply voltage, and selecting the actual duty cycle includes scaling down a default duty cycle based on an amount by which the actual supply voltage exceeds the default supply voltage.

13. The method of claim 11, wherein the actual duty cycle is selected based on a ratio between the default supply voltage and the actual supply voltage.

14. The method of claim 7, wherein identifying the default supply voltage of the relay includes retrieving from a memory an indication of the default supply voltage of the relay.

15. The method of claim 7, wherein identifying the actual supply voltage of the relay includes executing a handshake with a controller of a battery that is used to open and close the relay to discover a voltage that is produced by the battery.

16. A relay, comprising:
a moving contact;
a coil that is arranged to actuate the moving contact; and
a controller that is configured to:
identify a default supply voltage of the relay;
identify an actual supply voltage of the relay;
select an actual duty cycle based on the actual supply voltage and the default supply voltage; and
drive the coil by using a signal that has the selected actual duty cycle.

17. The relay of claim 16, wherein the default supply voltage of the relay is a supply voltage the relay is rated for, and the actual supply voltage of the relay is a voltage that is produced by a power source used to open and close the relay.

18. The relay of claim 16, wherein the actual supply voltage is greater than the default supply voltage, and selecting the actual duty cycle includes scaling down a default duty cycle based on an amount by which the actual supply voltage exceeds the default supply voltage.

19. The relay of claim 16, wherein the actual duty cycle is selected based on a ratio between the default supply voltage and the actual supply voltage.

20. The relay of claim 16, wherein identifying the default supply voltage of the relay includes retrieving from a memory an indication of the default supply voltage of the relay.

21. The relay of claim 16, wherein identifying the actual supply voltage of the relay includes executing a handshake with a controller of a battery that is used to open and close the relay to discover a voltage that is produced by the battery.

22. A system, comprising:
a moving contact;
a coil that is arranged to actuate the moving contact; and
a controller that is configured to:
identify a default supply voltage of the relay;
identify an actual supply voltage of the relay;
detect whether the actual supply voltage matches the default supply voltage;
when the actual supply voltage matches the default supply voltage, drive the coil with a signal that is provided by a power source without performing pulse-width modulation on the signal; and
when the actual supply voltage does not match the default supply voltage, perform pulse-width modulation on the signal that is provided by the power source and drive the coil with the pulse-width modulated signal.

23. The system of claim 22, wherein the default supply voltage matches the actual supply voltage when the actual supply voltage is the same as the default supply voltage, and the default supply voltage does not match the actual supply voltage when the actual supply voltage is different from the default supply voltage.

24. The system of claim 22, wherein the default supply voltage matches the actual supply voltage when the absolute value of a difference between the default supply voltage and the actual supply voltage does not exceed a predetermined threshold, and the actual supply voltage does not match the default supply voltage when the absolute value exceeds the predetermined threshold.

25. The system of claim 22, wherein the default supply voltage of the relay is a supply voltage the relay is rated for, and the actual supply voltage of the relay is a voltage that is produced by a power source used to open and close the relay.

26. The system of claim 22, further comprising selecting an actual duty cycle based on the default supply voltage and the actual supply voltage, wherein the pulse-width modulation is performed in accordance with the actual duty cycle.

27. The system of claim 26, wherein the actual supply voltage is greater than the default supply voltage, and selecting the actual duty cycle includes scaling down a default duty cycle based on an amount by which the actual supply voltage exceeds the default supply voltage.

28. The system of claim 26, wherein the actual duty cycle is selected based on a ratio between the default supply voltage and the actual supply voltage.

29. The system of claim 22, wherein identifying the default supply voltage of the relay includes retrieving from a memory an indication of the default supply voltage of the relay.

30. The system of claim 22, wherein identifying the actual supply voltage of the relay includes executing a handshake with a controller of a battery that is used to open and close the relay to discover a voltage that is produced by the battery.

31. A non-transitory computer-readable medium storing one or more processor-executable instructions, which, when executed by a processing circuitry of a relay, cause the processing circuitry to perform the operations of:
identifying a default supply voltage of the relay;
identifying an actual supply voltage of the relay;
selecting an actual duty cycle based on the actual supply voltage and the default supply voltage; and
driving a coil of the relay by using a signal that has the selected actual duty cycle.

32. A non-transitory computer-readable medium storing one or more processor-executable instructions, which, when executed by a processing circuitry of a relay, cause the processing circuitry to perform the operations of:
identifying a default supply voltage of the relay;
identifying an actual supply voltage of the relay;
detecting whether the actual supply voltage matches the default supply voltage;
when the actual supply voltage matches the default supply voltage, driving a coil of the relay with a signal that is provided by a power source without performing pulse-width modulation on the signal; and
when the actual supply voltage matches the default supply voltage, performing pulse-width modulation on the signal that is provided by the power source and driving the coil of the relay with the pulse-width modulated signal.
